(19) United States
(12) Patent Application Publication
(10) Pub. No.: US 2002/0115341 A1
(43) Pub. Date: Aug. 22, 2002

(54) Computer controlled order filling system

(76) Inventors: Mark L. Hein, Napa, CA (US); Petraas H. Bhatena, Pleasanton, CA (US); David M. Chervin, Berkeley, CA (US); Julius M. Davault III, Vacaville, CA (US); Jeanne Marie Johnson, Concord, CA (US); Hazem N. An Nashif, Pinole, CA (US); Parixit Manibhai Patel, Union City, CA (US); Richard Michael Propp, Albany, CA (US); Christine Roa, Bay Point, CA (US); Robert Bruce Sanderson, Benicia, CA (US); Gary L. Smith, Richmond, CA (US); Hoa Tram, San Pablo, CA (US); Sunil Chowdary Vemulapalli, San Francisco, CA (US); Steve Li An Yuan, San Mateo, CA (US)

Correspondence Address: Attn: Todd A. Noah, DERGOSITS & NOAH LLP, Suite 1450, Four Embarcadero Center, San Franciso, CA, 94111, US

(21) Appl. No.: 10/128,709

(22) Filed: Apr. 22, 2002

Related U.S. Application Data
(63) Continuation-in-part of application No. 09/544,877, filed on Apr. 7, 2000.
(60) Provisional application No. 60/362,302, filed on Mar. 6, 2002.

(51) Int. Cl. H01R 12/24

(52) U.S. Cl. 439/495

(57) ABSTRACT

An order filling system used in an inventory storage area having a controlling computer and a network of user interface devices which each have a microprocessor, memory and the ability to independently process information. The controlling computer coordinates communications with the user interface devices through poll broadcasts. The controlling computer transmits order information to the user interface devices which display the order information to assist workers in picking inventory order items. When the workers pick the specified quantity of an order items they press confirmation buttons on the user interface devices which transmit confirmation signals to the controlling computer. If special processing is required, the user interface device is capable of performing various tasks which reduces the processing requirements of the controlling computer.

This application is a continuation in part of copending U.S. patent application Ser. No. 09/544,877 filed Apr. 7, 2000 titled “Electrical Strip For Order Filling System” which is hereby incorporated by reference.

### BACKGROUND OF THE INVENTION

Manufacturing companies and distribution centers commonly have warehouses which store inventory items. When the inventory items are needed, an order is placed and the requested inventory items are picked (removed) from the storage area. A worker is instructed to pick specific order items and places the picked items into a portable container. After all items of the order have been picked, the container of picked items is transported to a shipping area. Various methods have been developed for picking orders. For example, orders may be printed on a sheet of paper used by a worker to gather the requested items, however a purely manual order filling process is prone to human error.

Computerized order filling systems have been developed which assist workers in picking orders. These order filling systems identify the location and quantity of order items on a visual displays mounted in the storage area. These order filling systems may include a controlling computer electrically connected to numerous user interface devices mounted throughout a storage area. The user interface devices may have visual displays and buttons. The visual displays indicate the order item to be picked and buttons are used by the worker to inform the computer that an item has been picked.

As workers travel through the storage area, the controlling computer transmits signals that control lights mounted on storage racks. These lights indicate the location of the next order item to be picked and guide the worker through the storage area. The lights also indicate the pick quantity of the order item. After the specified quantity of the item is picked, the worker presses a button which sends a signal to the controlling computer confirming the pick. The computer repeats the process until the worker has picked all items in the order. The controlling computer must also manage all special processing situations including: adjusting the order due to a lack of inventory or transitioning to a new carton if a first carton becomes full.

A problem with the described order filling system is that a single controlling computer must control all functions and communications between the computer and the other components of the order filling system. Order information is sent from the controlling computer to the user interface devices which display order filling information to workers. The user interface device then captures button presses and transmits them to the controlling computer which must process the button signals. The button signals may indicate that an order line item pick is complete or that there is a problem with the order. Because the controlling computer simultaneously processes numerous orders and all of the communications between the system components, the controlling computer can become overloaded. This overloading of the controlling computer results in slower processing of orders and inefficiency.

Another problem with the prior art order filling systems is that the user interface devices are not easily modified. The order filling system may need to be modified whenever inventory items in a storage area are changed. This type of modification may be frequent in installations where inventory items are frequently changed. When the order filling system is changed, the user interface devices may need to be moved or the functionality of the user interface devices may need to be changed. Because the user interface devices are controlled by hardware and hard wiring, the user interface devices are not easily moved to different locations in the order filling system. In order to move a user interface unit, new wiring is required for the new location. Similarly, the functionality of the user interface device is not easily changed. Because the controlling computer provides all functionality to the user interface devices, the controlling computer must be reprogrammed to change the functionality of the user interface devices. Also, if the buttons of the user interface devices are labeled, the labels must be manually changed to correspond to any modifications of the user interface devices.

What is needed is a system which has more flexible user interface devices and distributes the order processing requirements amongst the system components to prevent overloading the controlling computer.

### SUMMARY OF THE INVENTION

The present invention is an order filling system having a controlling computer which communicates directly and/or via wireless communications with numerous user interface devices configured in a network. Each user interface device has a microprocessor and memory and may also have a visual display and an input device. Computer programs are stored in the memory of the user interface devices allowing each user interface device to independently perform various order processing tasks. The user interface devices are mounted through out an inventory storage area to assist workers during the order filling process.

In a typical embodiment of the order filling system, a worker indicates that he or she is ready to process an order by scanning an ID number on a barcode label affixed to a carton using a hand held scanner that is attached to a user interface device. The controlling computer associates the next order to be picked to the ID on the bar-code label. The controlling computer determines the location of a worker by detecting the location of the user interface device that transmitted the signal. The controlling computer also determines the most efficient sequence for picking the order items starting with the item closest to the worker. The controlling computer transmits order information for the closest order item to the associated user interface device, which displays the order information for a worker. The worker reads the order information and attempts to pick the specified quantity of the order item. The worker then inputs information corresponding to his or her actions.

The user interface device receives the workers input and may perform independent processing. The processing may be: confirming a pick for the order line quantity, adjusting the pick quantity because there is insufficient inventory to complete the pick, suspending an order because a carton is full, restarting an order with a new carton, and various other functions. The user interface device performs the necessary processing and sends a message indicating the processing performed to the controlling computer. The controlling computer interprets the message from the user interface device and transmits order information for the next closest order item to the next user interface device. The process is repeated until the order is complete.

Communications between the controlling computer and the user interface devices may include polling broadcast. When the controlling computer is ready to receive signals from the user interface devices, it transmits an enabling message to the user interface devices, waits for a response and then transmits a disabling message. This polling broadcast may be transmitted several times per second. If the user interface devices have information to report from worker interaction, the user interface devices respond to the enabling signal by transmitting information to the controlling computer. The controlling computer acknowledges the receipt of each message from a user interface device by sending an acknowledgement signal to the user interface device. The ability of user interface devices to operate independently allows order filling processes to be initiated by the workers (client driven) rather than the controlling computer. The controlling computer continuously monitors the user interface devices for signals indicating worker interaction. Prior art order filling systems typically required the controlling computer to periodically monitor every user interface device, whether or not the device had been used by the worker.

The independent processing capabilities allow the user interface devices to perform many types of processing through software programs stored in memory. The user interface device may be programmed to display a menu of locally available program functions on a visual display. The worker can use buttons on the user interface device to access the menu of stored programs which perform various tasks. The user interface devices may also be easily reconfigured when software improvements are made or when the order filling system needs to be modified. Through this reconfiguration process, the menu of locally available functions can be altered.

When new, custom and updated programs are developed to improve the order filling system performance, the programs may be downloaded from the controlling computer through the network to some or all of the networked user interface devices. Some or all of the programs in the user interface device memory may also be erased to remove obsolete information and make room for newer programs. These flexible user interface devices are an improvement over prior art user interface devices which had fixed processing capabilities based upon the wiring of the buttons and were not capable of performing multiple tasks or being reprogrammed.

Because the user interface devices are self contained processing units, they may also have independent functionality which does not require interaction with the controlling computer. For example, the user interface device may have a self-diagnostic program which allows self testing of hardware components. If a problem is detected, the user interface device can report the malfunction to the user through a visual display or inform the controlling computer by sending a digital signal.

The controlling computer can independently monitor the health of the user interface devices, using the self-test capability of the devices. The controlling computer periodically sends messages to the user interface devices to perform the self-test function. If the user interface devices detect a problems, or fail to respond to the self-test message after a configured number of re-tries, the controlling computer can direct the system operator to replace malfunctioning user interface devices.

In an embodiment, the order filling system may be expanded by connecting multiple groups of controlling computers and user interface devices. A central computer may be connected to all of the controlling computers which are each connected to separate groups of user interface devices. In operation, the central computer may receive order information and store it in a central database. The central computer may divide the order into multiple groups corresponding to line items associated with each controlling computer. The central computer may then simultaneously transmit the order information for each controlling computer so that the order may be processed by a plurality of workers at the same time. The controlling computers process each portion of the order information as described above. When all of the items associated with each controlling computer are picked, the controlling computer sends a signal to the worker indicating that the portion of the order is complete. The picked items are then moved to the shipping area where they are combined with the other portions of the order before shipping.

The inventive order filling system is substantially different than the prior art order filling systems because much of the required computer processing is performed at the user interface devices rather than the controlling computer. The distribution of processing among many microprocessors reduces the processing dependence on the controlling computer. Further, because the user interface devices initiate communications, communications activity with the controlling computer over the internal network is reduced, improving the communications performance.

### BRIEF DESCRIPTION OF THE DRAWINGS

The invention is herein described, by way of example only, with reference to embodiments of the present invention illustrated in the accompanying drawings, wherein:

FIG. 1 is a diagram of the order filling system;

FIG. 2 illustrates various types of user interface devices;

FIG. 3 is a diagram of the order filling system with a server computer;

FIG. 4 illustrates a top view of the electrical strip;

FIG. 5A illustrates a cross section of the electrical strip;

FIG. 5B illustrates a cross section of the electrical strip;

FIG. 6A illustrates a cross section of the housing;

FIG. 6B illustrates a cross section of the housing and electrical conductors;

FIG. 6C illustrates a cross section of the housing and electrical strip;

FIG. 6D illustrates a cross section of the electrical strip mounted on a base;

FIG. 7 illustrates a cross section of an order filling system component;

FIG. 8 illustrates a cross section of the electrical strip, housing and component assembled;

FIG. 9 illustrates a front view of the electrical strip, housing and components mounted on a shelf unit; and

FIG. 10 illustrates a cross section view of the electrical strip, housing and component mounted on a shelf unit.

### DETAILED DESCRIPTION

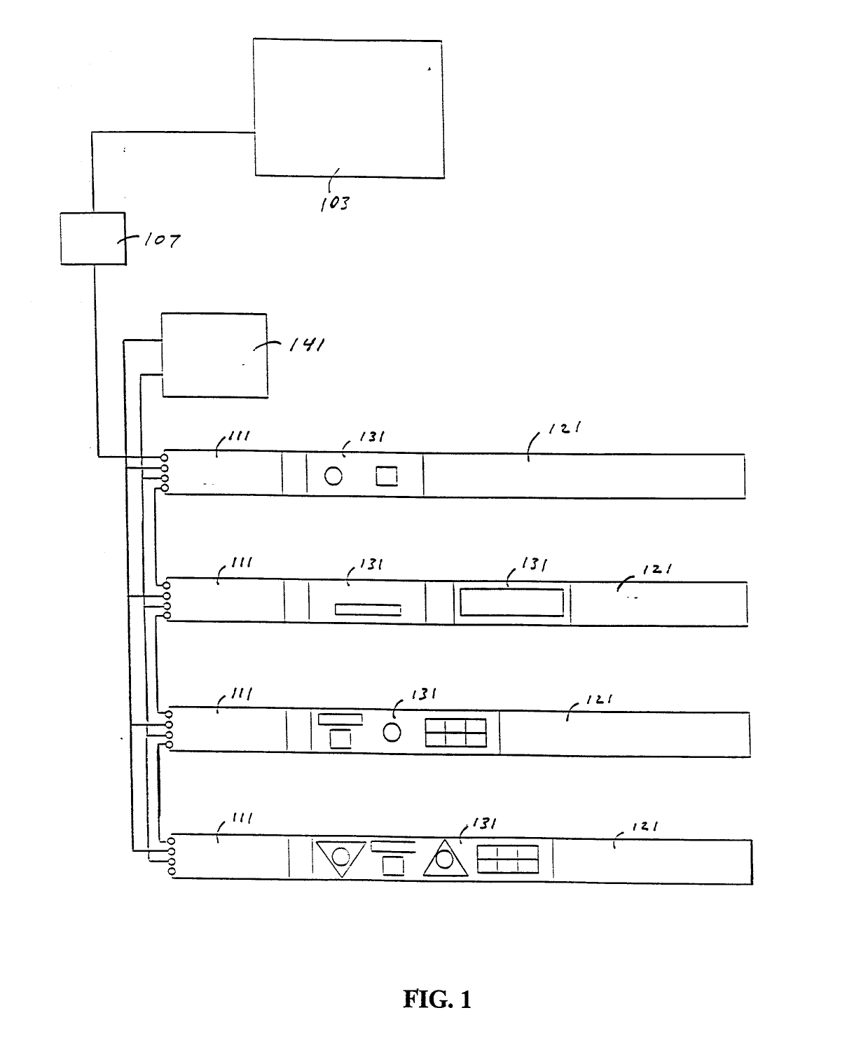

FIG. 1 is a diagram showing the components of the inventive order filling system 100. The controlling computer 103 communicates with user interface devices 131 which are attached to tracks 121 that are mounted throughout the inventory storage area. Each track 121 houses an electrical strip (not shown) which has multiple conductors. The electrical strips run the lengths of the tracks 121. Many user interface devices 131 may be mounted on a single track 121 and the user interface devices are in contact with the conductors of the track's electrical strip.

Interconnect modules 111 are mounted on the tracks 121 and provide external electrical connections to the electrical strip conductors. Signals from the controlling computer 103 are transmitted to the electrical strips of each track 121 through the interconnect modules 111 forming a network of user interface devices 131. A power source may also be connected to the interconnect modules 111 to provide electrical power to the electrical strips and user interface devices 131 mounted on the tracks 121.

The controlling computer 103 receives orders and transmits order information to the user interface devices 131. The controlling computer 103 runs an order filling program and has a microprocessor, random access memory and read/write memory such as a hard disk drive. The controlling computer 103 runs order filling software which will be described in more detail below. The appropriate speed and memory of the controlling computer 103 depends upon the size and complexity of the order filling system installation. Suitable computers may be: a pentium processor based PC (the normal platform) or an IBM RS/6000 or a HP 9000.

In an embodiment, communications between the controlling computer 103 and the user interface devices 131 may be transmitted over a single conductor. The controlling computer 103 transmits and receives all signals through a converter/repeater 107. The communications between the controlling computer 103 and the converter/repeater 107 may be point to point local signals for communications between two devices such as an RS-232 type signal. The converter/repeater 107 converts the point to point signals into multi-point signals capable of longer transmissions such as an RS-485 type signal. Multi-point signals are also suitable for communications with multiple user interface devices each having an individual address. Signals from the controlling computer 103 are converted by the converter/repeater 107 into multi-point signals which are transmitted to each of the user interface devices 131 in the order filling network. The user interface devices 131 transmit multi-point signals to the converter/repeater 107 which converts the multi-point signals into point to point signals and transmits the signals to the controlling computer 103. Because the signals from the user interface devices 131 have an identification code, the controlling computer 103 is able to determine which user interface device has transmitted a signal.

The converter/repeater 107 may also isolate and protect the controlling computer 103 from electrical surges in the network that could potentially damage the controlling computer 103. The isolation may be accomplished by converting the electrical signals into optical signals and then converting the optical signals back into electrical signals. The conversion into an optical signal prevents electrical surges from being transmitted through the converter/repeater 107. In an embodiment, the converter/repeater 107 may be an opto-isolated RS232-RS485 converter model IRSFC24FB-C made by the RE Smith Co. which has automatic data direction control to avoid data collisions. In an alternative embodiment, the controlling computer 103 communicates directly with the user interface devices 131 via multi-point signals and a converter/repeater 107 device is not required.

Each user interface device 131 has an internal memory and a microprocessor capable of running various order filling programs. In the preferred embodiment, the downloaded programs and configuration information is stored on a flash memory device which does not rely upon an external power source to retain processing information. The order filling programs and other information may be downloaded to the user interface devices 131 mounted on the tracks 121 of the network from the controlling computer 103. This ability to download information and programs allows the user interface devices 131 to be easily modified and reprogrammed.

The order filling programs with can be used with each user interface device 131 depends upon the input and output components of the user interface device 131. Various types of user interface devices may be used with the inventive order filling system. Some of the user interface devices have simple input and output components which may be used for simple tasks. Other user interface devices have more sophisticated components capable of running complex program instructions.

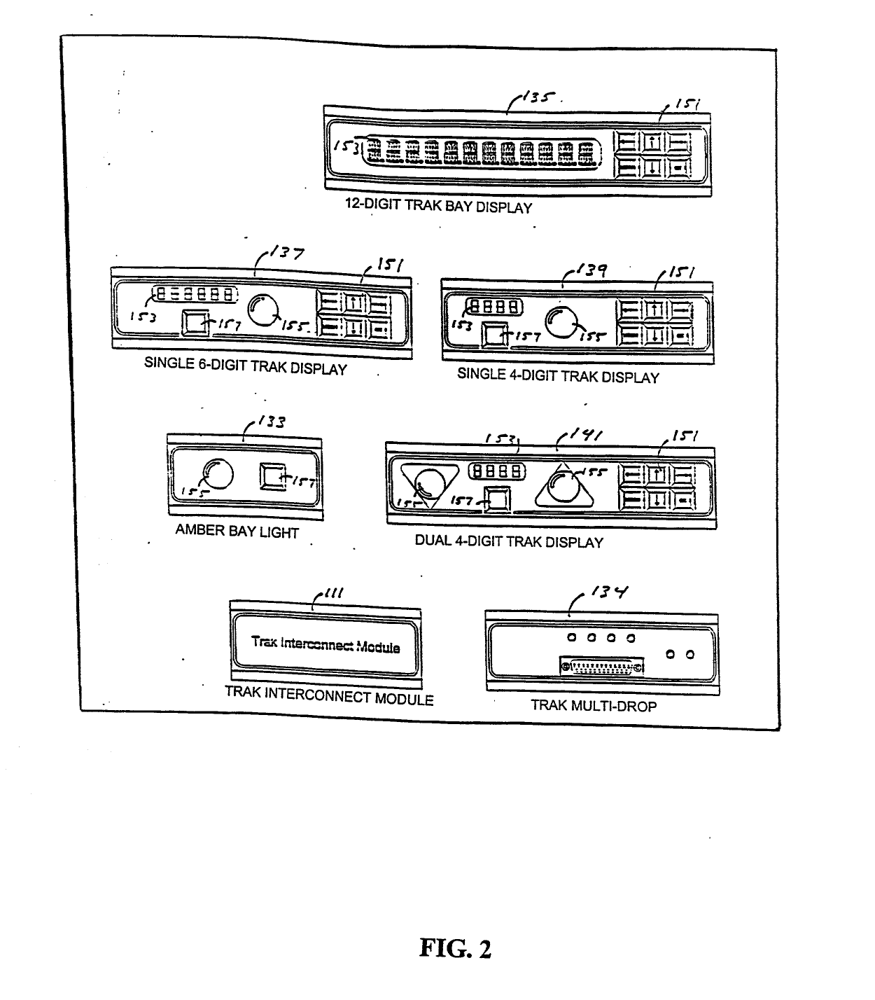

With reference to FIG. 2, some of the user interface devices compatible with the order filling system are illustrated. The “bay light” 133 user interface device which has a single button and a single light. The “bay light” 133 user interface device may be programmed to indicate the order item to be picked by illuminating the light and confirm that the order item has been picked when the button is pressed. More sophisticated programs may not be suitable for the bay light 133 user interface device because of the display and input limitations.

More sophisticated user interface devices are the “12-digit bay display” 135, the “single 6-digit display” 137, the “single 4-digit display” 139, and the “dual 4-digit display” 141. These user interface devices each have keypads 151 and alphanumeric displays 153. A desired order filling program may be accessed by using the keypad 151 to scroll through a menu of different programs described on a visual display 153 and select the desired program. Some of these user interface devices also have lights 155 which indicate that the user interface device has order information and a pick confirmation button 157. In some cases, where the user interface device is associated with multiple inventory locations, the alpha numeric displays 153 indicate which inventory location is associated with the order.

Another user interface device is the “multi-drop” 134 which has an input terminal, such as an RS-232 type port which allows an input device having a compatible connector to communicate with the order filling network. The multi-drop 134 receives signals from connected devices and may convert these signals into multi-point type signals and transmit these signals to the controlling computer. The input device attached to the multi-drop 134 may be a bar code reader which is used to read identification bar codes on cartons, inventory items and worker badges. In an embodiment, multi-drops 134 with bar code scanners are mounted on the tracks through out the order filling system network. Although identification information may be transmitted to the controlling computer manually through a keypad on a user interface device, bar code reading devices provide a more efficient means for transmitting identification information to the controlling computer. In other embodiments, any other device having a compatible communications port may be connected to a multi-drop 134 on the order filling system network.

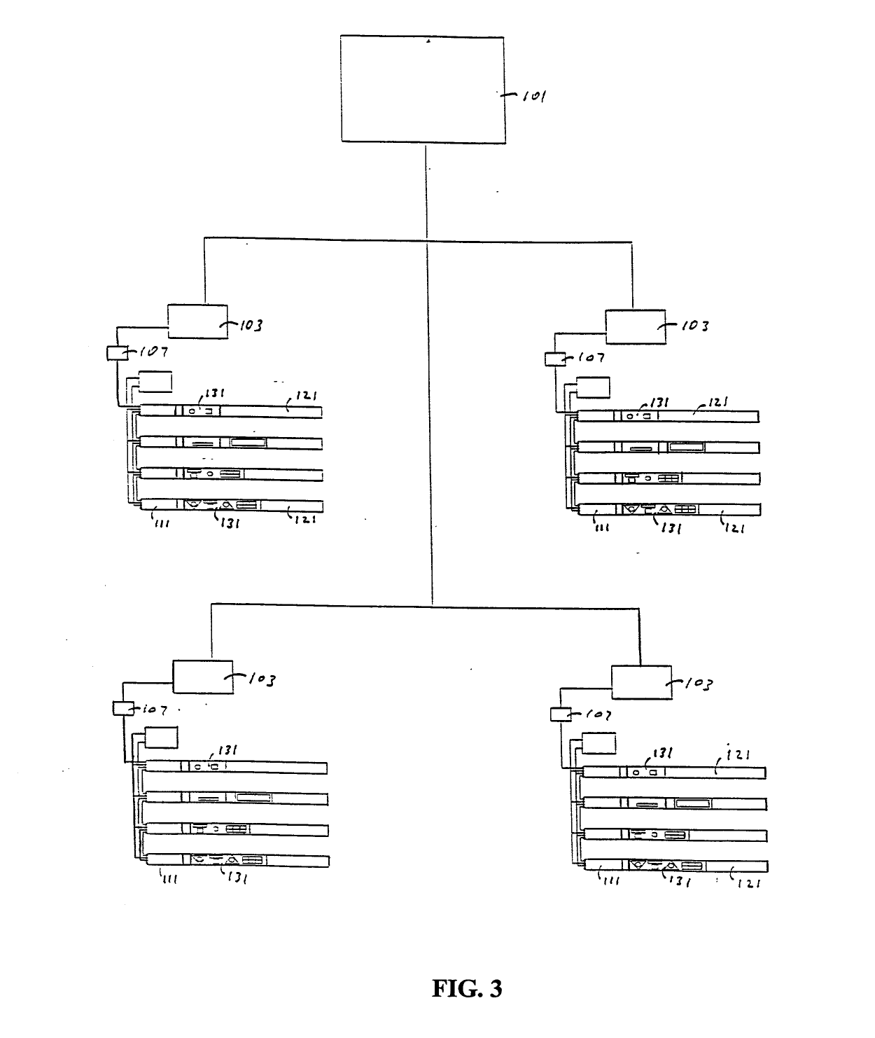

With reference to FIG. 3, an embodiment of the order filling system is illustrated which includes a server computer 101 which is connected to multiple controlling computers 103. This embodiment is suitable for large storage areas having many inventory items because the many user interface devices 131 can be dispersed amongst several controlling computers 103 rather than relying on a single controlling computer 103. Each controlling computer 103 may be associated with a different region or zone of a large storage area communicates with the user interface devices 131 mounted in the associated zone. The server computer 101 receives orders and divides the order items into partial orders for each different zone of the user interface device network. The server computer 101 then transmits the partial orders to each controlling computer 103.

The controlling computers 103 processes the assigned partial order independently by communicating directly with the user interface devices associated with the order items. The independent operation may be interrupted if there is a problem with the order processing which requires the attention of the server computer 101. Order problems which requires server computer 101 attention may include: order adjustment because of a lack of inventory, order interruption, additional carton required because a first carton is full, etc.

The following is a description of the processing steps used in a preferred embodiment of the order filling system. The server computer 101 receives an order and divides the order by zone based upon the locations of the inventory items. The controlling computer 103 receives an electronic order for its zone having multiple line items from the server computer 101. The controlling computer 103 indicates that it is ready to start a new order by transmitting a string display message “NEXT LABEL” to the bay displays 135 of the zone's user interface device network. The user interface devices receive the message and display the string “NEXT LABEL” on all bay displays135. The controlling computer 103 then monitors the user interface device network, using a poll broadcast (described in more detail below), for a signal from a worker indicating that he or she is ready to fill an order.

When the worker is ready to fill an order he or she scans a generic bar coded label called a “license plate” with a bar code reader connected to a multi-drop user interface device 131. Each license plate is associated with, and affixed to, a carton which is used to hold the picked items during the order filling process. The controlling computer 103 acknowledges receipt of the license plate information and sends the server computer 101 a message that the license plate has been inducted. The server computer 101 inducts a license plate by associating the license plate with an order. If the license plate has not been previously inducted, the server computer 101 associates a new order with the license plate. If the license plate was previously inducted, the server computer 101 identifies the order previously associated with the license plate.

Once a license plate is inducted and associated with an order, the controlling computer 103 queries the server computer 101 for all order items in the worker's zone and the server computer 101 responds by sending the order lines for the zone to the controlling computer 103. The controlling computer 103 receives the order lines for the zone and transmits order information to every user interface device 131 associated with the items for the order lines in the zone. After a worker picks all order items of the partial order for a zone, the worker receives a signal through the user interface devices 131 indicating that the order items for the zone have been picked. The partial orders for the other zones may be processed simultaneously by other workers in the other zones. When the partial orders are completely picked, the workers then moves the carton containing the order items to a central shipping area where the entire order may be gathered, packaged and shipped.

The order filling system may have two order filling modes, “all pick” and “one pick.” In the all pick mode, all of the user interface devices having order items display the quantity of items to be picked. The worker travels through the storage area and can pick the order items in any sequence. The controlling computer 103 monitors the user interface network, preferably using poll broadcast, described in more detail below. After picking each order item, the worker presses a pick complete button and the user interface device 131 transmits a pick confirmation signal to the controlling computer 103. After the user interface devices receives acknowledgement of the pick confirmation signal from the controlling computer 103, the user interface device 131 clears its display to indicate to the worker that the pick of item has been recorded by the system. The worker then proceeds to the next order item, picks the specified quantity and again presses the pick complete button. This process continues until all order items are picked.

In “one pick” pick mode, the controlling computer 103 transmits order information to all user interface devices 131 associated with the order, however only one user interface device 131 displays the order information. All other user interface devices 131 “cloak” the information by concealing the order information. The controlling computer 103 determines the most efficient sequence of picks based upon the relative locations of the order items. The controlling computer 103 may also start the pick sequence with the order item closest to the worker. The controlling computer 103 may determine the closest order item based upon the location of the user interface device 131 used by the worker used to scan the license plate. The controlling computer 103 then monitors the user interface 131 network. The worker locates the first order item, picks the specified quantity and presses the pick complete button. The controlling computer 103 receives the pick confirmation signal and transmits de-cloak instructions for the next closest order item. The described order filling process continues until all order items for the zone are picked.

After the last order item in the zone is picked, the controlling computer 103 transmits a message which is displayed on the user interface device 131 displays. The controlling computer 103 may transmit a “PASS” string if the picks for the zone are complete, but there are other incomplete picks in at least one other zone. If all picks in all zones are complete, the controlling computer transmits a “DONE” string. When the picks for the zone are complete, the worker to moves the carton containing the order items to the shipping area.

In the preferred embodiment, the controlling computer 103 utilizes polling broadcast to coordinate communications between the controlling computer 103 and the networked user interface devices 131. The controlling computer 103 continuously transmits an “enabling” signal to the entire network or a subgroup of user interface devices 131. The controlling computer 103 then monitors the network for signals from the user interface devices 131 and subsequently transmits a “disabling” signal. The user interface devices 131 may transmit signals only after receiving an enabling signal and the controlling computer 103 only transmits signals to the user interface devices 131 after it transmits a disabling signal. This enabling/disabling signal sequence cycles several times per second. When the network receives the enabling signal, only user interface devices 131 which have information for the controlling computer 103 transmit a response signal. For example, when a worker completes a pick and presses the pick confirmation button, the user interface device 131 waits until an enabling signal is transmitted and then responds by transmitting the pick confirmation signal to the controlling computer 103.

During poll broadcasting, when two user interface devices 131 respond to an enabling signal at exactly the same time, the signals may collide requiring both signals to be re-transmitted. Each user interface device 131 may be programmed to wait slightly different predetermined periods of time before re-transmitting to avoid a second signal collision. Because the polling broadcast cycles several times per second, the signals are typically very brief and user interface device 131 activities are not continuously being transmitted, signal collisions are very rare. However, because multiple user interface devices 131 may be used simultaneously, signal collisions are always a possibility.

An alternative to poll broadcasting is individual communications with each user interface device 131. The controlling computer 103 can monitor the user interface devices 131 for activity by sequentially transmitting individually status update queries to each user interface device 131 and waiting for the individual responses. This process may require a substantial period of time if there are many user interface devices 131. Individual communications is also more complex because the order filling software must be programmed to individually address each status update query, also each time an additional user interface device 131 is added, the software must be modified. Although the individual communications eliminates the possibility of signal collisions, this benefit does not outweigh the inefficiency and complexity problems in comparison to the poll broadcast method.

The order filling process proceeds as disclosed above as long as there is sufficient inventory of each order item and the carton is large enough to hold all of the picked items. If, however, there is insufficient inventory or there is insufficient space in the carton to accommodate the entire order, special processing may be required. If the worker attempts to pick an inventory item and the required quantity of the inventory item is unavailable, the worker selects the adjust quantity program stored in the user interface device 131 memory. The worker inputs the actually quantity picked through the user interface keypad. In an embodiment, arrow keys may be used to adjust a displayed quantity by scrolling down to the actual pick quantity. When the actual pick quantity is displayed, the worker then presses the button to submit the adjusted quantity. The user interface device 131 may process the adjusted quantity by comparing the actual pick quantity to the allowable pick range. In an embodiment, the minimum (and maximum) allowable quantity is sent by the controlling computer 103 as part of the order information. In the typical embodiment, the minimum allowable quantity is zero and the maximum allowable quantity is the original order quantity. If the actual pick is within the allowable range, the adjusted pick information is transmitted to the server computer 101 to generate an adjustment to the order that accounts for the lower shipped quantity. If the actual pick quantity is outside the allowable range, the user interface device indicates that the pick quantity entered by the worker is not allowed and requires entry of an allowable pick quantity. For example, the worker may enter a pick quantity that is more than the original order quantity in error. In this instance, the user interface device would reject the entry of this quantity that is more than the maximum allowable quantity.

In an alternative embodiment, a quantity adjustment is processed by the controlling computer 103. When the worker comes to a location that has less product than is required by the order, the worker uses the menu function of the user interface device to select the adjust quantity function. The user interface device 131 requests permission to adjust the pick quantity from the controlling computer 103. If the controlling computer 103 allows the quantity adjustment, a “cloak” signal is sent to all user interface devices and all quantity information which had been displayed is concealed. An “uncloak” signal is then sent to the user interface device having the inventory shortage and the worker inputs the actual pick quantity through the keypad. The user interface device 131 checks the quantity to make sure that it is within the allowed range. If the adjustment is allowable, the adjusted pick information is transmitted to the controlling computer 103 which then sends an adjusted pick complete message to the server computer 101. The controlling computer 103 then instructs all units in the zone to uncloak the previously sent pick and the order process proceeds in the described manner.

The hold feature can be used to suspend an order. An order can be suspended for various reasons including a lack of inventory. The worker can access the hold program through a program in the user interface device 131. In an embodiment, the order is suspended by scanning the license plate before the associated order is complete. The license plate information is transmitted to the controlling computer 103 and the user interface device 131 displays “HELD” acknowledging that the order is being suspended and that the carton is being set aside. The worker can then process a new or different existing order. When the worker is ready to resume the suspended order, the license plate is scanned and license plate information is transmitted to the server computer 101. The server computer 101 recognizes the previously inducted license plate and transmits the associated order to the controlling computer 103. The controlling computer 103 transmits the partially processed order information to the user interface devices 131 and the worker can continue processing the order from where it was stopped.

Special processing may also be required if the carton used to hold and transport the picked items becomes too full to hold any additional order items. When a carton becomes nearly full, the worker may access the “FULL” process from a user interface device using the menu options on the user interface unit. The worker may pick some of the last order item to fill the carton and input the partial pick quantity through the keypad. The user interface device 131 then transmits the partial pick quantity for the last item and a FULL processing request to the controlling computer 103 which sends the FULL message to the server computer. The server computer 101 “closes” the full carton, instructs the user interface devices for the zone to display the message “SCAN CARTON” or “SEW LABEL” and waits for a new license plate/carton to induct. for the remainder of the order. The worker scans a new license plate with a bar code scanner and the identification information for the new carton is transmitted to the server computer 101. The server computer 101 verifies that the license plate is new and inducts the new license plate with the remainder of the suspended order. The controller reprocesses the order and sends revised order information to the user interface devices 131. The order processing then continues with the new license plate and carton from the point that the order was suspended.

Inquiries are another type of special processing which can be performed by the user interface devices 131. Inquiries include: SKU, order, location and last pick. The SKU query is used to display the SKU number for the inventory item stored at the location. The order query is used to check the order number associated with the current pick. The location query is used to show the location ID of the user interface device. The last pick query is used to show the location ID and quantity of items picked during the last confirmed pick.

For all inquiries, the worker accesses the requested information through the keypad. The inquiry is transmitted through the controlling computer 103 to the server computer 101 which transmits the response back through the controlling computer 103 to the user interface device 131. To display the requested information, the controlling computer 103 instructs the user interface devices 131 to cloak, concealing all information from the current order so that the requested information is displayed on the user interface device 131. The worker presses a confirmation button after receiving the requested information and the order filling process resumes.

Other types of processing are diagnostic checks of the user interface devices. When the controlling computer 103 is idle, it can perform health checks of the user interface devices 131. In an embodiment, the controlling computer 103 selects a random user interface device 131 and sends a health check message to the selected user interface device 131. The selected user interface device 131 responds by running a diagnostic health check program. If the user interface device 131 is operating correctly, it sends a message confirming proper operation to the controlling computer 103. The controlling computer 103 notes that the selected user interface device 131 passed the diagnostic check. The controlling computer 103 continues to randomly select and check the other user interface devices 131. If a defect in the user interface device is detected, an error message is sent through the controlling computer 103 to the server computer 101 indicting that the user interface device 131 may have a malfunction. The server computer 101 transmits a signal to a supervisor indicating that the user interface device 131 may be defective and requesting that a person to physically check the device 131.

The user interface devices 131 may also have a self-diagnostic program which may be accessed through the keypads. If the user interface device 131 is operating correctly, it will confirm its proper status on the visual display. If however the self-diagnostic program detects a problem, the user interface device will indicate that there is a defect and possibly additional information regarding the type of defect on the visual display. As discussed, the user interface devices are interchangeable, thus if the defective the user interface device 131 may be replacement by snapping in a replacement device 131 and downloading the required replacement information from the order filling system.

In the preferred embodiment, the order filling system is “client driven” meaning that the progress of the order filling is controlled by signals from workers. The result of the client driven configuration is that the order filling system assists the workers rather than controlling the workers. More specifically, with a client driven system, the worker can control various aspects of the order filling including: the pick mode, the sequence of the pick order, alterations in the pick quantity, and suspension of the pick. In contrast, most order filling systems are “system driven” with the controlling computer directing the actions of the worker.

Although the inventive order filling process has been described in a configuration that includes both a controlling computer 103 and a server computer 101, it is contemplated that another embodiment of the invention does not require a server computer 101. In this embodiment, the controlling computer 103 performs all of the functions described as being performed by the server computer 101 and the controlling computer 103. The controlling computer 103 will be able to perform these additional tasks as processing and communications capabilities continue to improve.

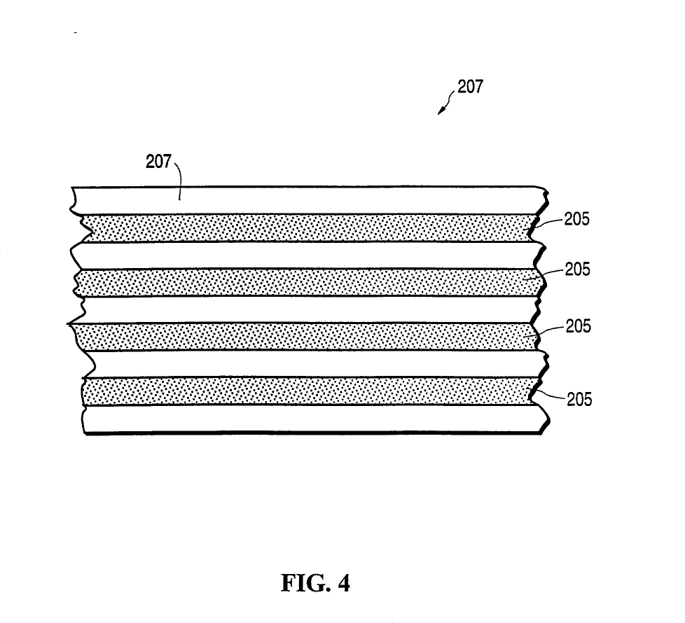

As discussed, the user interface devices 131 are mounted on tracks 121 having internal electrical strips which form a network. Referring to FIG. 4, a top view of the inventive electrical strip 203 is illustrated. The electrical strip 203 includes conductors 205 mounted in parallel along the length of the insulative strip 207. The conductors 205 may be used to transmit electrical signals from a central computer and/or electrical power along the length of the electrical strip 203.

Figures SA and 5B are cross section views of the electrical strip 203 showing the conductors 205. The insulative strip 207 is made of an electrical insulator material. In the preferred embodiment, the insulative strip 207 is flexible extruded plastic, however the insulative strip 207 may alternatively be, ceramic, fiberglass, dielectric or any other suitable non-conductive material. The insulative strip 207 has a constant width and may be made to any length by any known manufacturing method.

The conductors 205 may be any electrically conductive material. In the preferred embodiment the conductors 205 are copper, but may also be aluminum, silver, gold, brass, steel or any other conductive material. When copper, aluminum, brass, steel or other conductive metals are used as the conductors 205 a low resistance corrosion protection layer should be applied to exposed surfaces. In FIG. 3, the conductors 205 are illustrated as being circular in cross section, however many other shapes are suitable including: thin foil, oval, triangular, rectangular, polygon or any other suitable cross section shape. Similarly, the conductors 205 are illustrated as being solid but may alternatively comprise a multiplicity of strands bundled together.

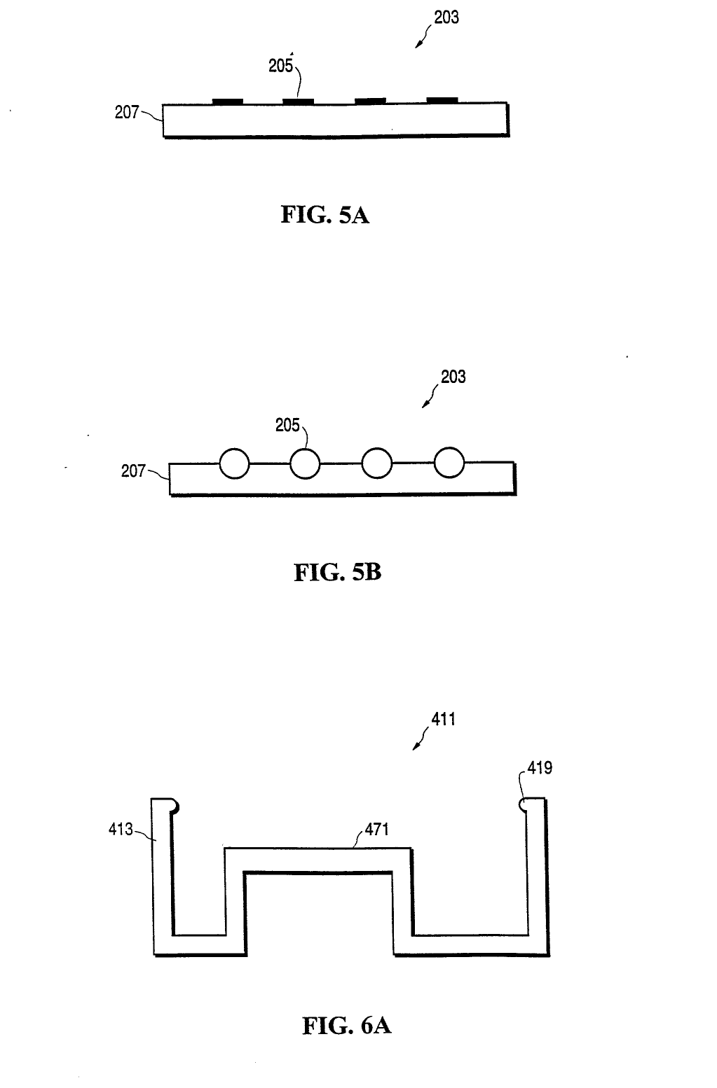

Referring to FIG. 5A, in the preferred embodiment, the electrical strips 203 are fabricated with conductors 205 which are strips of metal foil that are cut to the desired width and attached in parallel to the insulative strip 207 with an adhesive. The electrical strips 203 may be stored in rolls and cut to the desired length according to the installation site requirements.

Alternatively, as illustrated in FIG. 5B, the electrical strip 203 may have conductors 205 which are rods embedded in the insulative strip 207. There are several methods of attaching conductors 205 to the insulative strip 207. The conductors 205 may be heating and may be pressed into the insulative strip 207 such that the plastic melts at the contact areas. When the melted plastic material solidifies, the solid conductors 203 are partially embedded and security attached to the insulative strip 207. The conductors 205 may also be coextruded with the insulative strip 207, such that the insulative strip 207 is formed in contact with the conductors 205. The insulative strip 207 may alternatively be fabricated with grooves and each conductor 205 may be adhesively or otherwise attached within each of the grooves.

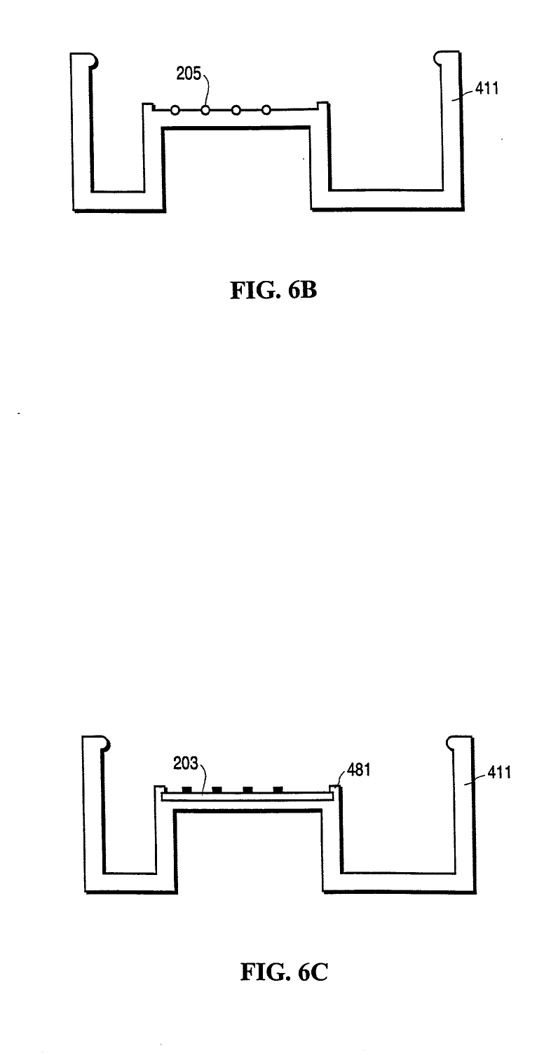

The electrical strip 207 is typically mounted in a housing or on a base upon which inventory picking system components can be mounted. FIG. 6A illustrates a cross section view of the housing 411. The sides 413 of the housing 411 have flanges 419 which are used to mount the system components on the housing 411. The electrical strip 203 may be attached to the flat surface 471 in the housing 411 with adhesives, screws, rivets or any other known fastening mechanism.

Referring to FIG. 6B, in an alternate embodiment, the housing 411 may be made of an insulative material and the conductors 205 may be attached directly to the housing 411. In this embodiment an insulative strip is not required. The conductors 205 may be attached to the insulative plastic housing 411: with an adhesive, by heating and pressing the conductors 205 into the housing 411 such that the plastic melts at the contact areas, by coextrusion or by any other suitable means.

FIG. 6C illustrates a cross section view of an alternate embodiment of the housing 411. In this embodiment, the housing 411 has flanges 481 under which the electrical strip 203 is mounted. The electrical strip 203 may either slide below the flanges 481 through one end of the housing 411 or snapped into position. The electrical strip 203 may be snapped into the housing 411 by placing one edge of the electrical strip 203 below one of the flanges 481 and deforming the electrical strip 203 such that the other edge slides under the opposite flange 481.

FIG. 6D illustrate yet another cross section view of an alternative embodiment where the electrical strip 203 is mounted on a base 423 which does not have sidewalls. In this embodiment, the order filling system components or covers define a recessed area and are attached to the base 423 by flanges, grooves, screws or any other fastening means. The electrical strip is located within the recessed area of the system components or covers.

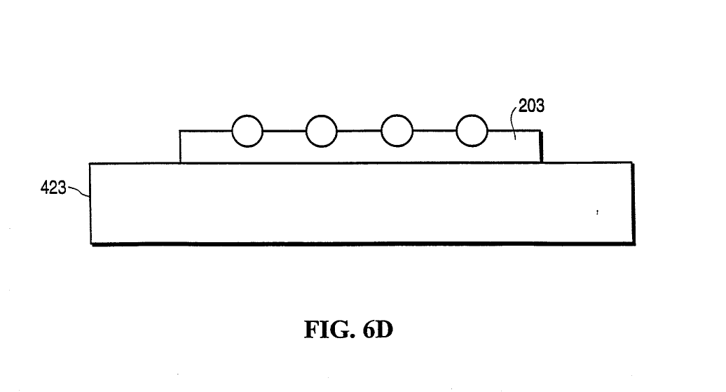

FIG. 7 illustrates a cross section view of a component 531 of an inventory pick system. The component 531 has flanges 539 which engage the flanges of the housing (not shown). The component 531 may include: lights, alphanumeric displays, keypads, transmitters, receivers, radio frequency tags and any other components that are compatible with an order filling system. The component 531 has electrical contacts 535 which are located at the bottom of the component 531 and electrically connect the component 531 to the electrical strip (not shown).

As discussed, many components 531 may be electrically connected to a single electrical strip (not shown), which is electrically connected to a controlling computer (not shown). In order for the controlling computer to transmit signals to individual components 531, each component 531 has an addressable integrated circuit 533 which allows the component 531 to distinguish addressed control signals transmitted from the controlling computer.

The addressable integrated circuits may utilize several well known methods of operation including: Carrier Sense Multiple Access/Collision Detect (CSMA/CD) or Poll/Select. In either method, the data packets or messages transmitted between the addressable integrated circuits or the between the addressable integrated circuits and the controlling computer include an address signal which identifies the intended recipient of the message. CSMA/CD is a protocol for carrier transmission access. In this method, a device such as an addressable integrated circuit or controlling computer can send messages over the electrical strip at any time. The devices monitor the electrical strip and sense whether the signal transmission conductor of the electrical strip is idle and available for use. If signal transmission conductor is idle, the device begins to transmit its message. If another device has tried to send at the same time, a collision is said to occur and both messages are discarded. Each device then waits a previously configured amount of time and retries until successful in getting its message sent. User interface devices are configured with different amounts of wait time to prevent collisions on the re-send of information.

Poll/Select is another type of electrical signal protocol in which the host computer controls the transmission of data to the devices. The default state of the system is for all of the addressable integrated circuits to be waiting for a message from the host computer. The host computer transmits a ‘Poll’ message which is received by all of the addressable integrated circuits. Each addressable integrated circuit decodes the ‘Poll’ message and based on the address portion of the message, determines whether it is the intended recipient of the message. The addressable integrated circuit which is the intended recipient of the message is said to be ‘Selected’ by the ‘Poll’ message and responds to the controlling computer by transmitting a message containing the information requested by the host computer. Although the addressable integrated circuits are described as operating with serial process signals, it is well known that the conductive strip is also compatible with a multiplexed process signals or other signal protocols used to individually control multiple components sharing common electrical connections.

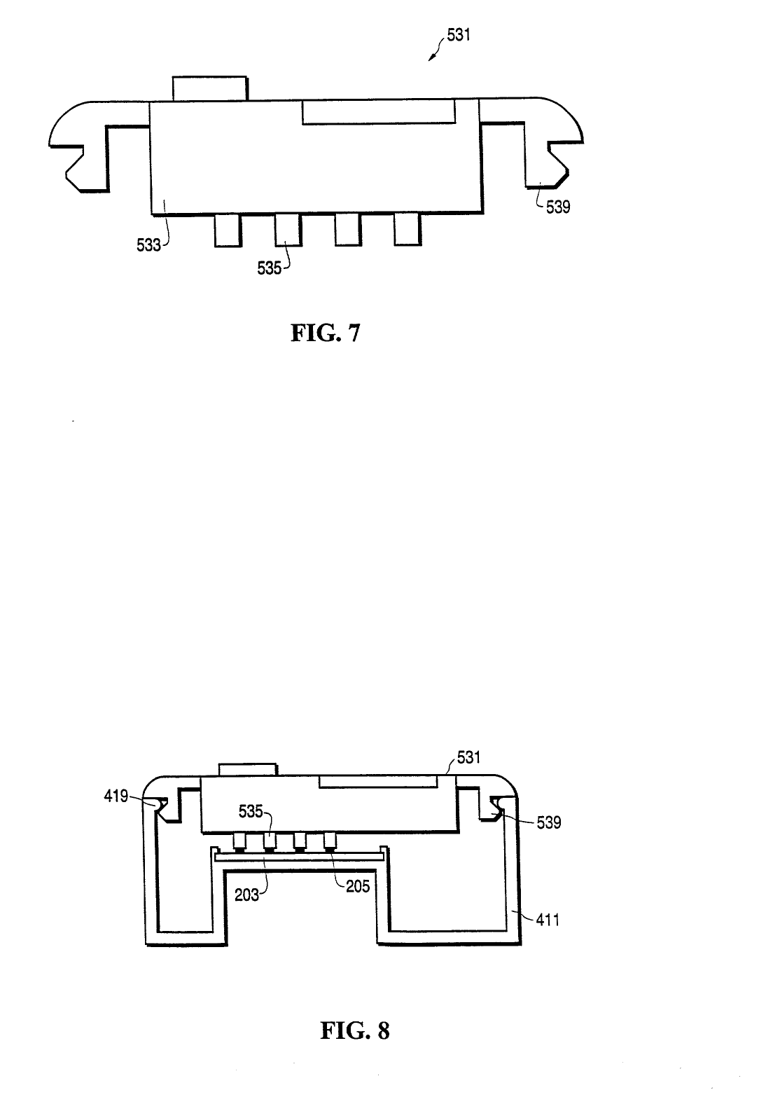

FIG. 8 illustrates cross sections of the electrical strip 203, housing 411 and component 531 assembled together. The electrical strip 203 is attached to the housing 411 and is used to transmit signals between the controlling computer (not shown) and the component 531. The electrical contacts 535 may be spring loaded such that when the component 531 is attached to the housing 411, a spring force holds the electrical contacts 535 against the conductors 205 producing a low resistance electrical connection. The order filling system may typically utilize many components 531 all connected to a common electrical strip 203 and mounted to a single housing 411. To attach the component 531 to the housing 411, the side walls 413 of the component 531 may be flexed so that flanges 539 of the components 531 can engage the flanges 419 of the housing 411.

In other embodiments of the present invention, alternative groove and flange configurations may be used to connect the components and covers to the housing or the base, for example flanges in the housing or base may engage grooves in the component. Further, the component may be attached to the housing or base by different mechanisms including: screws, adhesives, Velcro, elastic bands, tapes, crimping, welding or any other well known attachment mechanism. In the preferred embodiment, the components are attached to the housing or base with a simple releasable mechanism which allows the component to be easily repaired, replaced or moved.

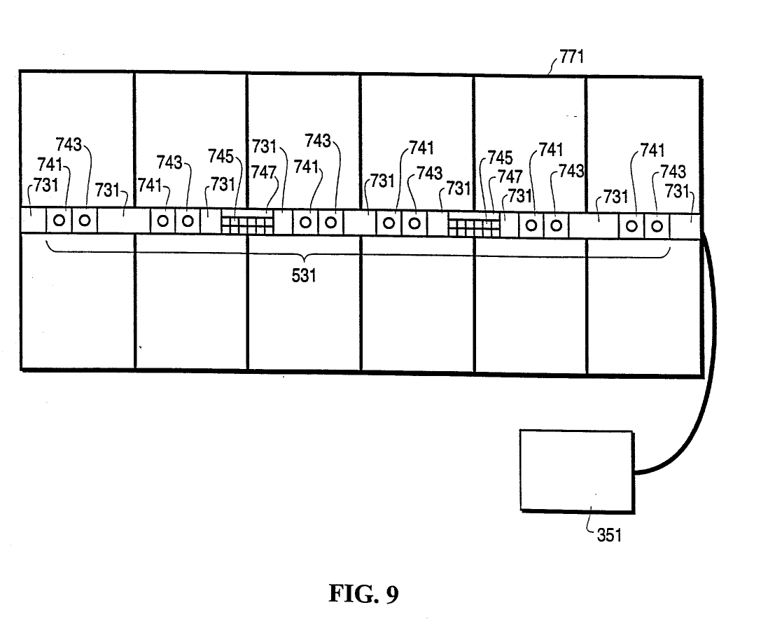

Referring to FIG. 9, the components 531 are illustrated mounted to the front of a storage area shelf 771. The components 531 include: lights 741, buttons 743, keypads 745, alphanumeric displays 747 and other electrical devices. All of the components 531 are individually controlled by a controlling computer 351 which is also connected to the electrical strip (not shown). Non-functional covers 731 are attached to the housing to shield the electrical strip from exposure at sections of the housing that are not covered by components 531.

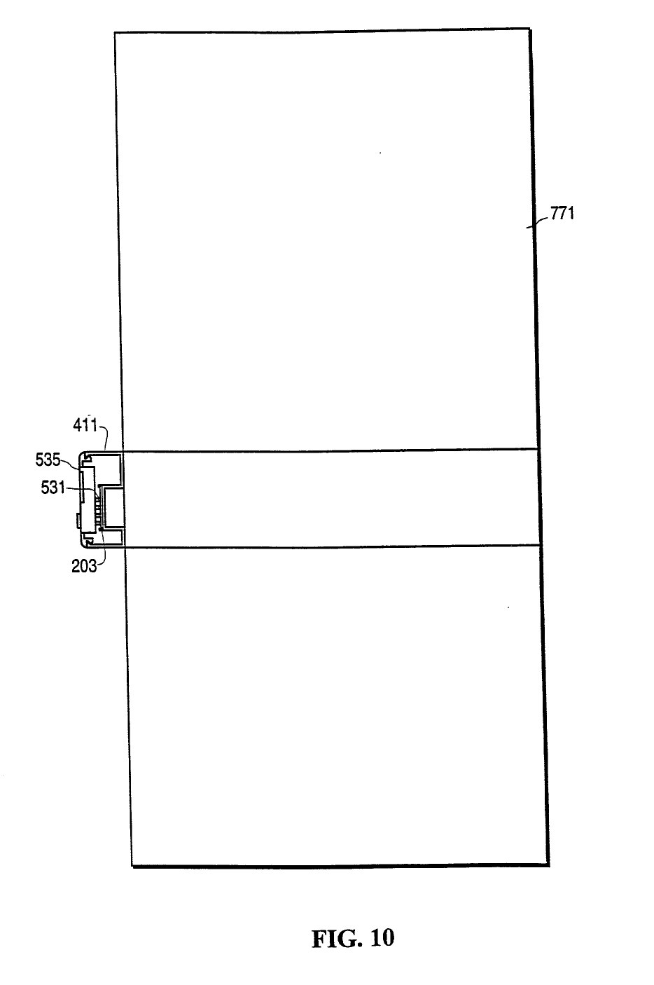

FIG. 10 illustrates a cross section view of a component 531 mounted on a housing 411 which is mounted on the front of a storage area shelf 771. As discussed, the component 531 has electrical contacts 535 which are electrically connected to the electrical strip 203. The electrical strip 203 is mounted in the housing 411 which is attached to the storage area shelf 771 with screws, adhesives, Velcro, rivets, welding material or any other suitable fastening mechanism. Other components 531 mounted along the housing 411 are similarly electrically connected in parallel to the electrical strip 203.

Because all order picking system components share common electrical conductor rods, there is no need to connect each of the components to the central computer with dedicated wiring. Thus, when an order picking system is installed, electrical strips can simply be installed on all of the required shelves without regard to wiring requirements of the components to be mounted on the shelves. Because dedicated component wiring is not required the order picking system installation time is substantially decreased when the inventive electrical strip is used. Similarly, maintenance of the order filling system is greatly simplified because broken components can simply be removed and repaired or replaced without rewiring the entire length of the housing. Further if the storage area is reorganized in the future, the order picking system components can simply be moved to facilitate the relocation of inventory items.

In alternative embodiments, the user interface devices may communicate with the controlling computer through wireless means. In this embodiment, the user interface device would operate in the same way disclosed above but are capable of transmitting and receiving signals through a wireless transmitter/receiver mechanism. The wireless communications may be radio frequency or optical transmissions which are well known in the communications art. The user interface devices in this embodiment would be mobile and may be mounted on movable units which hold inventory items. Because the user interface devices are not connected to the electrical strip, they may require a battery pack to supply operating power. In an embodiment, the computer controlled order filling system may include both track mounted user interface devices and mobile user interface devices having wireless communication capabilities.

In the foregoing, a computer controlled order filling system has been described. Although the present invention has been described with reference to specific exemplary embodiments including the order filling system, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An order filling system comprising:
a plurality of user interface devices each having a microprocessor, a receiver/transmitter and a memory for storing an individual identification code and a program; and
a controlling computer for transmitting a digital signal to one or more of the plurality of user interface devices;
wherein each user interface device is associated with at least one inventory storage location.

2. The order filling system of claim 1 wherein the plurality of user interface devices process information independently.

3. The order filling system of claim 2 wherein each of the plurality of user interface devices independently transmits a signal to the controlling computer.

4. The order filling system of claim 1 wherein the digital signal transmitted by the controlling computer to the plurality of user interface devices is a line item of an order.

5. The order filling system of claim 1 wherein the digital signal transmitted by the controlling computer to the plurality of user interface devices is a portion of general order information.

6. The order filling system of claim 1 wherein the digital signal is a polling broadcast transmitted by the controlling computer to the plurality of user interface devices.

7. The order filling system of claim 6 wherein one of the user interface devices responds to the polling broadcast by transmitting a signal to the controlling computer.

8. The order filling system of claim 6 wherein if a first user interface device transmits a first reply and a second user interface device transmits a second reply to the controlling computer simultaneously, resulting in a message collision, the first user interface device waits a first predetermined period before re-transmitting the first reply and the second user interface device waits a second predetermined period of time which is different than the first predetermined period of time before re-transmitting the second reply.

9. The order filling system of claim 1 wherein the plurality of user interface devices are mounted on a track containing an insulative strip and a plurality of conductors which are mounted on the insulative strip.

10. The order filling system of claim 1 wherein the user interface device can be moved and associated with a different inventory storage location.

11. The order filling system of claim 1 wherein at least one of the plurality of user interface devices includes: a visual display and an input device.

12. The order filling system of claim 11 wherein the visual display is an alphanumeric display and the input device is: a button, a keypad, an RS-232 port, a barcode reader, or a radio frequency device.

13. The order filling system of claim 1 wherein the digital signal is a program which is downloaded from the controlling computer to the memory of the one or more of the plurality of user interface devices.

14. The order filling system of claim 11 wherein a diagnostic program is stored in the memory of the user interface devices which allows a user to check the functionality of each user interface device by inputting a command to run the diagnostic program through the input device and the results of the diagnostic program are displayed on the visual display.

15. The order filling system of claim 1 wherein the digital signal is a health check signal transmitted to one of the plurality of user interface devices and the one user interface device independently runs a diagnostic program and transmits a correct operation signal to the controlling computer if the user interface device is operating correctly.

16. The order filling system of claim 4 further comprising:
a server computer for transmitting the order to the controlling computer.

17. A method of filling an order comprising the steps:
providing an order filling system comprising: a controlling computer and a plurality of user interface devices each having a microprocessor, a receiver/transmitter and a memory for storing an identification code and a program;
transmitting a line item of the order from the controlling computer to a first user interface device of the plurality of user interface devices; and
displaying a quantity of an item to be picked on a visual display of the first user interface device.

18. The method of filling an order of claim 17 further comprising:
transmitting pick signals from the controlling computer to all user interface devices associated with the order signal; and
displaying a quantity of an item to be picked on the visual displays of the user interface devices associated with the order signal.

19. The method of filling an order of claim 17 further comprising:
transmitting an identification signal to the controller computer identifying a container into which pick items of the order are placed.

20. The method of filling an order of claim 17 further comprising the step of:
transmitting a modified pick signal from the first user interface device to the controlling computer if the quantity of the item to be picked in the displaying step is not picked by the user.

21. The method of filling an order of claim 17 further comprising the steps:
transmitting a full signal from one of the plurality of user interface devices to the controlling computer if the user inputs a signal indicating that the user does not have the capacity to pick any further items; and
suspending the transmittal of the pick signal from the controlling computer to the plurality of user interface devices.

22. The method of filling an order of claim 19 further comprising the step:
transmitting a message indicating that the user has the capacity to pick items; and
resuming the transmittal of pick information from the controlling computer to the plurality of user interface devices.
